(19) United States
(12) Patent Application Publication
(10) Pub. No.: US 2006/0140147 A1
(43) Pub. Date: Jun. 29, 2006

(54) Bandwidth allocation protocol for shared wireless networks

(76) Inventor: Jeroen Van Bemmel, Leiden (NL)

Correspondence Address: WILLIAMS, MORGAN & AMERSON, 10333 RICHMOND, SUITE 1100, HOUSTON, TX, 77042, US

(21) Appl. No.: 11/021,357

(22) Filed: Dec. 23, 2004

(51) Int. Cl. H04L 12/413; H04Q 7/00

(52) U.S. Cl. 370/329

(57) ABSTRACT

The present invention provides a method and an apparatus for allocating bandwidth for transmission to a first client device on a wireless network shared with a second client device. The method comprises sending a request-to-send indication to a transceiver node for transmitting data and in response to the request-to-send indication, receiving an indication at the first client device from the transceiver node to stay silent after transmitting the data. In this manner, in one embodiment, a controlled allocation of an available transmission bandwidth may be provided for shared wireless networks in a bi-directional communication system using a request-to-send (RTS)/clear-to-send (CTS) mechanism, controlling access to a wireless medium and coordinating usage of a wireless network. Specifically, an additional field, i.e., a “silence time” field may be added in a frame sent by an access point (AP). The “silence time” field may contain a value (e.g., in microseconds) that a receiver should minimally stay silent after transmitting the data. This additional field may be added to either an acknowledgement (ACK) frame for using a modified ACK frame or a CTS frame for using a RTS/CTS handshake (i.e., a modification to the CTS frame). Accordingly, a protocol extension to the Institute of Electrical and Electronics Engineers 802.11 standard defines a bandwidth allocation protocol which allows a wireless access point to control distribution of the available transmission bandwidth over a plurality of wireless client devices.

### BACKGROUND OF THE INVENTION

1. Field of the Invention

This invention relates generally to telecommunications, and more particularly, to wireless communications.

2. Description of the Related Art

Use of wireless networks is expected to increase dramatically as users discover the enhanced productivity and increased mobility that wireless communications provide. For example, a wireless local area network (LAN) lets users roam around a building with a laptop (equipped with a wireless LAN card) and stay connected to their network without being connected to a wire. The wireless LANs transfer data through the air using radio frequencies instead of cables, requiring a wired access point (AP) that plugs a plurality of wireless devices into a wired network.

As users experience the convenience of wireless connectivity, they are beginning to demand support for the same applications they run over today's wired networks. To this end, an Institute of Electrical and Electronics Engineers (IEEE) 802.11 standard refers to a family of specifications developed by the IEEE for wireless LAN technology. For example, a new standard proposed by the IEEE called 802.11b or Wi-Fi is making wireless LANS faster and easier to use. The IEEE 802.11 standard specifies an over-the-air interface between a wireless client and a base station or between two wireless clients. The IEEE 802.11 standard specification published in 1997 and is available from IEEE Operations Center, 445 Hoes Lane, Piscataway, N.J., 08854-1331, USA.

The IEEE 802.11 wireless networks form a shared medium in an unlicensed spectrum. The IEEE 802.11 standard defines two mechanisms for collision avoidance: Distributed Coordination Function (DCF) based on Carrier Sense Multiple Access with Collision Avoidance (CSMA/CA) (sensing the medium until it is idle, with exponential backoff) and Point Coordination Function (PCF) based on polling nodes for traffic (by the AP). Because wireless bandwidth availability is restricted, quality of service is increasingly important in the IEEE 802.11 wireless networks. In such wireless networks carrying multimedia traffic, it becomes useful to provide a Quality of Service (QoS) guarantee for multimedia traffic connections.

Quality of Service in IEEE 802.11 wireless networks is the subject of much past and present research. For example, the IEEE 802.11e specification, a proposed IEEE standard defines QoS mechanisms for wireless gear that gives support to bandwidth-sensitive applications such as voice and video. The IEEE 802.11e specification defines QoS extensions that provide relative QoS (prioritization of traffic classes), implementing statistical service differentiation. Other bandwidth allocation enforcement mechanisms exist at other layers in a network protocol stack, for example, traffic shaping with token buckets at the IP layer.

The IEEE 802.11e specification only provides eight classes and can only provide a statistical distribution of the wireless medium usage; it could not, for example, prevent a client from using the entire medium in a single-user scenario. The IEEE 802.11e specification based enhancements would require a significant redesign of the IEEE 802.11 standard based products. Moreover, once users pass the access control mechanisms, their usage of the medium is uncontrolled and determined by stochastical processes. Collisions resulting in packet errors increase with the number of users, to a point where no one is able to make use of the network anymore. Therefore, one problem is how to control or coordinate usage of a wireless network, allowing a wireless access point (AP) to control distribution of available bandwidth over a plurality of clients.

Request-to-send/clear-to-send (RTS/CTS) is a standard mechanism defined for the IEEE 802.11 standard which coordinates access to the wireless medium, to alleviate the problem of “hidden nodes” (nodes that are in range of the same AP but not of each other, and hence cannot sense the collisions they cause). Whenever a packet is to be transmitted, a transmitting node first sends out a ready-to-send (RTS) packet containing information on the length of the packet. When a receiving node receives the RTS packet, it responds with a clear-to-send (CTS) packet. After this RTS and CTS packet exchange, the transmitting node sends other data packets. Typically, when the data packets are received successfully, as determined by an error detection means, such as a cyclic redundancy check (CRC), the receiving node transmits an acknowledgment (ACK) packet. The RTS packet specifies how much time the sender needs. A CTS reply (from the AP) causes all nodes except the receiver to stay silent for the advertised amount of time. However, this mechanism does not provide controlled allocation of available transmission bandwidth.

The present invention is directed to overcoming, or at least reducing, the effects of, one or more of the problems set forth above.

### SUMMARY OF THE INVENTION

In one embodiment of the instant invention, a method is provided for allocating bandwidth for transmission to a first client device on a wireless network shared with a second client device. The method comprises sending a request-to-send indication to a transceiver node for transmitting data and in response to the request-to-send indication, receiving an indication at the first client device from the transceiver node to stay silent after transmitting the data.

In another embodiment, an article comprising a computer readable storage medium storing instructions that, when executed cause a processor-based system to send a request-to-send indication to a transceiver node for transmitting data on a wireless network shared between a first and a second client device and receive an indication at the first client device from the transceiver node to stay silent after transmitting the data in response to the request-to-send indication.

In yet another embodiment, a transceiver node is provided for use with a first client device on a wireless network shared with a second client device. The transceiver node comprises a controller and a memory coupled to the controller, the memory may store instructions for allocating bandwidth for transmission to the first and second client devices. The transceiver node further comprises a communication interface coupled to the controller. The communication interface is capable of sending downstream transmissions and receiving upstream transmissions over a virtual channel for upstream communication and downstream communication, the virtual channel to transmit and receive data in a series of frames including a first frame and a second frame, the first frame to provide a request-to-send indication for transmitting data to the transceiver node and the second frame to provide an indication from the transceiver node to the first client device to stay silent after transmitting the data in response to the request-to-send indication.

In still another embodiment, a bi-directional communication system is provided in which a bandwidth allocation protocol is deployed for communicating with a plurality of wireless networks in cooperation with a server. The system comprises a virtual channel for upstream communication and downstream communication, a wireless access point capable of sending downstream transmissions and receiving upstream transmissions over the virtual channel and a plurality of wireless client devices capable of receiving the downstream transmissions and sending the upstream transmissions, at least one of the wireless client devices capable of sending a request-to-send indication to the wireless access point for transmitting data and receiving an indication from the wireless access point to stay silent after transmitting the data in response to the request-to-send indication.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a bi-directional communication system according to one illustrative embodiment of the present invention;

FIG. 2 illustrates a network protocol stack for use with the bi-directional communication system shown in FIG. 1 in accordance with one illustrative embodiment of the present invention;

FIG. 3 illustrates a shared wireless network in the bi-directional communication system shown in FIG. 1 according to one illustrative embodiment of the present invention;

FIG. 4A illustrates a format for a request-to-send (RTS) frame in the shared wireless network shown in FIG. 3 according to one illustrative embodiment of the present invention;

FIG. 4B illustrates a format of a clear-to-send (CTS) frame in the shared wireless network shown in FIG. 3 according to one illustrative embodiment of the present invention;

FIG. 5 illustrates a stylized representation of a method for allocating available bandwidth over a first and a second client device shown in FIG. 3 in accordance with one illustrative embodiment of the present invention; and

FIG. 6 illustrates a stylized representation of a method for controlling distribution of available bandwidth for transmission over a plurality of wireless client devices using a bandwidth allocation protocol that coordinates usage of a plurality of shared wireless networks in the bi-directional communication system shown in FIG. 1 in accordance with one illustrative embodiment of the present invention.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Generally, a bandwidth allocation protocol may support Quality of Service (QoS) guarantees across a plurality of wireless client devices in multimedia shared wireless networks. A protocol extension to the IEEE 802.11 standard may be provided. Specifically, an additional field, i.e., a “silence time” field may be added in a frame sent by an access point (AP). The “silence time” field may contain a value (e.g., in microseconds) representing a period of time for which a receiver should minimally stay silent after transmitting the data. By calculating an appropriate value for the “silence time,” the AP may thus set an upper limit on the transmission bandwidth used by a particular mobile station or a wireless client device in a shared wireless network. For example, this additional field may be added to either an acknowledgement (ACK) frame or a clear-to-send (CTS) frame.

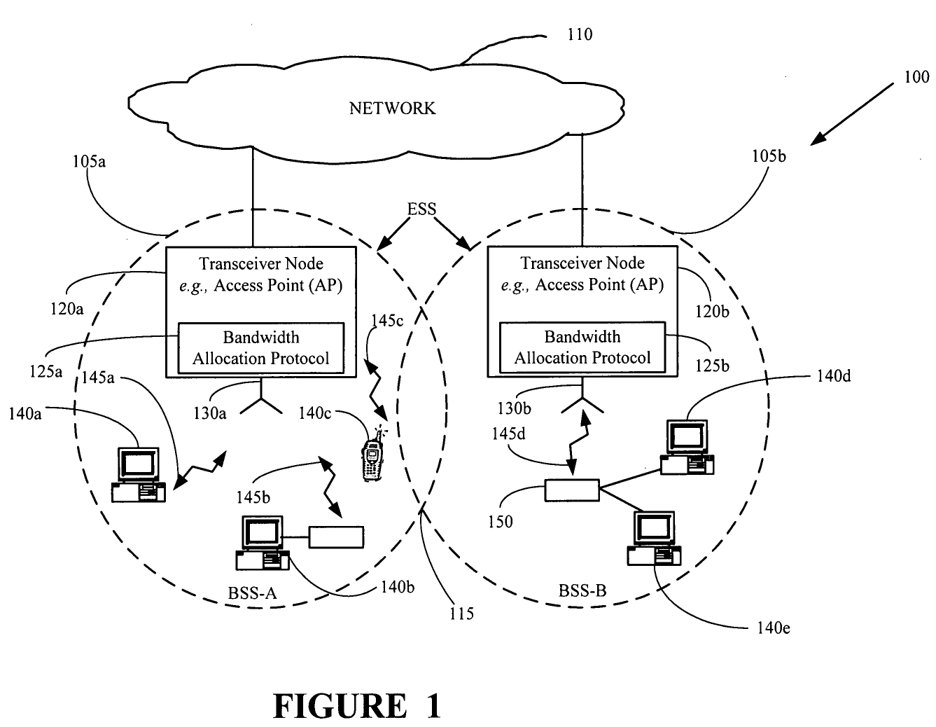

Referring to FIG. 1, a bi-directional communication system 100 includes a plurality of wireless networks, such as basic service sets (BSSs), BSS-A 105a, BSS-B 105b and a network 110, for example, an intergraded local area network (LAN) according to one embodiment of the present invention. The plurality of basic service sets BSS-A 105a and BSS-B 105b may form an extended service set (ESS) 115. While a basic service set (BSS) may be a set of wireless nodes or stations, such as a plurality of wireless client devices controlled by a single coordination function, which may be a logical function that determines when a station operating within a basic service set (BSS) is permitted to transmit and may be able to receive protocol data points (PDUs) via a wireless medium, the extended service set (ESS) 115 may be a set of one or more interconnected basic service sets 105a, 105b and the network 110 that appears as a single BSS at a logical link control layer to any mobile station associated with one of the two basic service sets 105a and 105b.

The wireless medium may be used to transfer protocol data units (PDU) between peer physical (PHY) layer entities of a wireless local area network (LAN). The wireless medium may be capable of handling cellular signals with cellular modems. For example, the wireless medium may operate according to the code division multiple access (CDMA) standard or the global system for mobile communications (GSM) standard, which is a land mobile pan-European digital cellular radio communications system.

In one embodiment, the basic service set (BSS-A) 105a comprises a plurality of wireless client devices 140a, 140b, and 140c, which may establish communications with a transceiver node 120a, such as an access point (AP). The access point may be a wireless device that transports data between a wireless network, e.g., the extended service set (ESS) 115 and a wired network, e.g., the network 110. The plurality of wireless client devices 140a, 140b, and 140c, such as laptops or personal digital assistants (PDAs), may connect to a wired LAN via the AP 120a, which may be a hardware device or software that acts as a communication hub. The AP 120a may provide security and extend the physical range of a wireless LAN. In one embodiment, the wireless LAN may use wireless transmissions, such as radio or infrared instead of phone lines or fiber-optic cable to connect the plurality of wireless client devices 140a, 140b, and 140c. The IEEE 802.11b, Wi-Fi, standard may provide the wireless LAN with two physical layer standards: 802.11b operating at 2.4 GHz (and delivering up to 11 Mbps at 250 feet max) and 802.11a operating at 5 GHz (and delivering up to 54 Mbps at 150 feet max). Alternatively, the IEEE 802.11g standard which also applies to wireless LANs may provide 20+Mbps in the 2.4 GHz band.

The transceiver node 120a may comprise a bandwidth allocation protocol 125a and an antenna 130a for communicating with the plurality of wireless client devices 140a, 140b, 140c over the wireless medium, such as an air interface over radio signals 145a, 145b and 145c. The transceiver node 120a provides access to different services, via the wireless medium for the plurality of wireless client devices 140a, 140b, 140c. Examples of the plurality of wireless client devices include a processor-based system, such as a computer 140a, a server 140b, and a cell phone 140c.

The bandwidth allocation protocol 125a may support Quality of Service (QoS) guarantees across the plurality of wireless client devices 140a through 140c within a multimedia shared wireless network. The QoS may be a measure of network performance that reflects the network's transmission quality and service availability. The QoS may come in the form of traffic policy in which the transmission rates are limited, guaranteeing a certain amount of bandwidth will be available to applications. Alternatively, the QoS may take the form of traffic shaping, which include techniques to reserve bandwidth for applications but not guarantee its availability. For example, the QoS standard for the IEEE 802.11 wireless LANs, called 802.11e provides QoS support for LAN applications, which may be critical for delay-sensitive applications such as Voice over Wireless IP (VoWIP). For example, the IEEE 802.11e standard may provide classes of service with managed levels of QoS for data, voice, and video applications.

The basic service set (BSS-B) 105b may comprise a transceiver node 125b, such as an access point (AP) including a bandwidth allocation protocol 125b. The transceiver node 120b may comprise an antenna 130b to communicate with a communication interface 150 shared between a first wireless client device 140d and a second wireless client device 140e. Using the communication interface 150, which may comprise an antenna, the first wireless client device 140d and the second wireless client device 140e may communicate with the transceiver node 120b over a radio signal 145d. Using the bandwidth allocation protocol 125a, the transceiver node 120a may control distribution of available bandwidth for transmission over the plurality of wireless client devices 140a-140c. In this manner, each transceiver node 120a, 120b may coordinate usage of a plurality of shared wireless networks, such as the basic service sets (BSS-A) 105a and (BSS-B) 105b.

The transceiver nodes 120a, 120b, which may be wireless access points in one embodiment, may form a bridge between a wireless local area network, such as the basic service set 105a and 105b and the network 110 which may comprise integrated local area networks (LANs) or wired LANs. In one embodiment, the transceiver nodes 120a and 120b may be a based station used in a cellular phone network. All communications between the network 110 and the plurality of wireless client devices 140a through 140e may go through the transceiver nodes 120a and 120b, respectively. To enable communications between the wireless client devices 140a through 140e and the network 110, the extended service set 115 includes a series of overlapping basic service sets (BSS-A) 105a and (BSS-B) 105b, each including a transceiver node, such as the transceiver nodes 120a and 120b.

Although the network 110 may be of any type of suitable network, such as a wired local area network, in one embodiment, the network 110 comprises an Ethernet LAN. The plurality of wireless client devices 140a through 140e may roam between the transceiver nodes 120a and 120b. The radio signals 145a through 145d may comprise radio frequency (RF) communications namely in a direct sequence spread spectrum (DSSS) and a frequency hop spread spectrum (FHSS), in one embodiment. For operation in the 2.4 Giga Hertz (GHz) ISM band, each of the plurality of wireless client devices 140a through 140e, in one embodiment, may comprise an IEEE 802.11 conformant medium access control (MAC) and a physical (PHY) layer interface to a wireless medium.

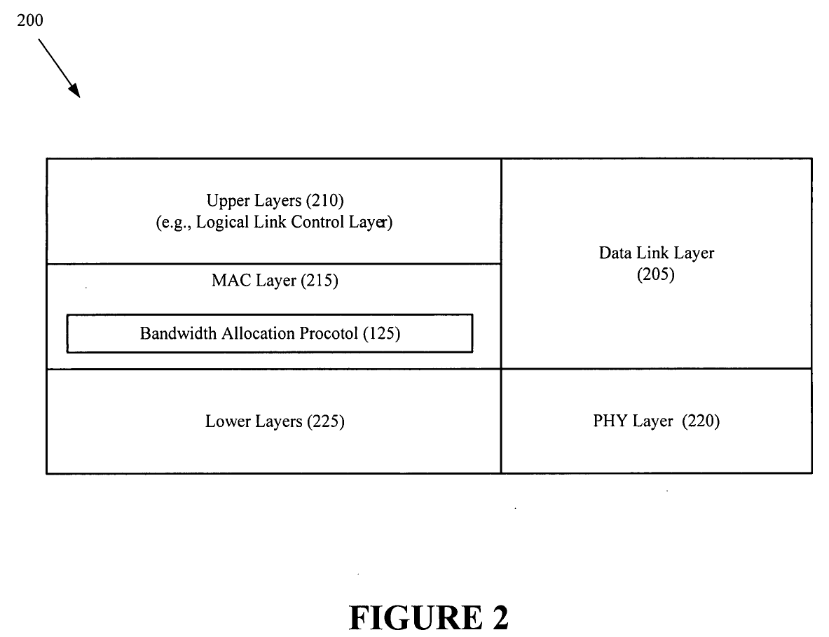

Referring to FIG. 2, a network protocol stack 200 for use with the bi-directional communication system 100 shown in FIG. 1 is depicted in accordance with one illustrative embodiment of the present invention. The network protocol stack 200 comprises a data link layer 205 which includes upper layers 210, such as a logical link control layer and a media access control (MAC) layer 215. The MAC layer 215 is a set of protocols that are responsible for maintaining order in the use of a shared wireless medium. For example, the IEEE 802.11 standard specifies a carrier sense multiple access with collision avoidance (CSMA/CA) protocol, according to which when a node receives a packet to be transmitted, it first listens to ensure no other node is transmitting. If a communication channel is determined to be available for transmission, the transmitting node then transmits the packet over the communication channel. Otherwise, the transmitting node selects a random “backoff factor” that determines an amount of time for which the transmitting node must wait until it is allowed to transmit its packet.

The data link layer 205 may be layer 2 of the Open Systems Interconnection (OSI) reference model developed by the International Standards Organization (ISO). The OSI model defines the concepts of the protocol and a service interface that includes seven layers, a physical layer, a link layer, a network layer, a transport layer, a session layer, a presentation layer and an application layer. These layers allow data packets to be transmitted from a variety of hardware to another hardware across the network 110 using various processes, such as a socket which may be an addressable entity.

The MAC layer 215 includes the bandwidth allocation protocol 125 shown in FIG. 1 according to one embodiment of the present invention. The network protocol stack 200 further includes a physical (PHY) layer 220 and other lower layers 225. While the data link layer 205 may take data from a network layer and pass it on to the physical (PHY) layer 220, the PHY layer 220 may handle the transmission of data between nodes and may use either direct sequence spread spectrum, frequency-hopping spread spectrum, infrared (IR) pulse position modulation, or the like. For example, the IEEE 802.11 standard makes provisions for data rates of either 1 Mbps or 2 Mbps, and calls for operation in the 2.4 to 2.4835 GHz frequency band (in the case of spread-spectrum transmission), which is an unlicensed band for industrial, scientific, and medical (ISM) applications, and 300 to 428,000 GHz for IR transmission.

By building the bandwidth allocation protocol 125 into the MAC layer 215 of the network protocol stack 200 consistent with the IEEE 802.11 standard, node starvation may be reduced or prevented and service providers may differentiate between multiple user classes provided by the 802.11e standard. The bandwidth allocation protocol 125 may provide bandwidth usage control at layer 2, i.e., the data link layer 205 may provide a relatively cheap implementation, both in terms of processing resources and complexity of design. That is, instead of using the IEEE 802.11e standard process requiring a significant redesign of the IEEE 802.11 standard compliant wireless access points or the transceiver nodes 120a and 120b, the bandwidth allocation protocol 125 may be implemented in the MAC layer 215 with relatively minor modifications to the existing devices. In one embodiment, the IEEE 802.11e standard, which provides eight classes, may provide a statistical distribution of the wireless medium usage, while the bandwidth allocation protocol 125 may control and coordinate usage of the shared wireless networks in the bi-directional communication system 100 shown in FIG. 1.

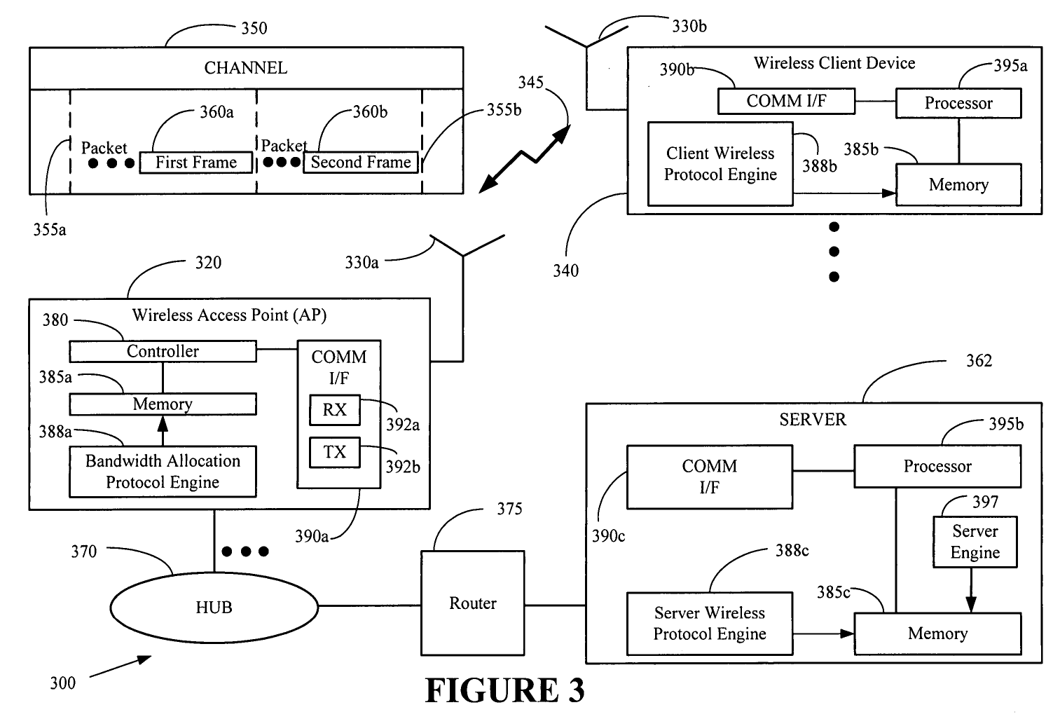

Referring to FIG. 3, a shared wireless network 300 is shown in accordance with one illustrative embodiment of the present invention. In the shared wireless network 300, a wireless access point (AP) 320 includes an antenna 330a to communicate with a wireless client device 340 that includes an antenna 330b. The wireless access point 320 may communicate with the wireless client device 340 over a virtual channel 350 for upstream communication and downstream communication in a radio frequency (RF) signal 345, in one embodiment. In this manner, the wireless access point 320 within the virtual channel 350 may transmit and receive data as data packets 355a and 355b in a series of frames including a first frame 360a and a second frame 360b. While the first frame 360a may provide a request-to-send indication for transmitting data to the wireless access point 320 from the wireless client device 340, the second frame 360b may provide an indication from the wireless access point 320 to the wireless client device 340 to stay silent after transmitting the data in response to the request-to-send indication.

The shared wireless network 300 may comprise a server 362. A conventional router 375 may couple the wireless access point 320 to the server 362 via a conventional hub 370, in one embodiment. In the plurality of wireless networks, such as the basic service sets 105a, 105b, in the bi-directional communication system 100 shown in FIG. 1 in which the bandwidth allocation protocol 125 is deployed in the MAC layer 215, as shown in FIG. 2, the available bandwidth for transmission over the plurality of wireless client devices 140a through 140e, such as for the wireless client device 340 may be controlled. That is, the wireless access point 320 may control and coordinate usage of the shared wireless network 300, in accordance with one embodiment.

The wireless access point 320 may comprise a controller 380, a memory 385a coupled to the controller 380 and storing instructions for allocating bandwidth for transmission to the wireless client device 340. To this end, in one embodiment, the memory 385a may store a bandwidth allocation protocol engine 388a. The wireless access point 320 may further comprise a communication interface (COMM I/F) 390a capable of sending downstream transmissions and receiving upstream transmissions over the virtual channel 350. The communication interface 390a may include a receiver (RX) 390a for upstream communication and a transmitter (TX) 392b for downstream communication.

Likewise, the wireless client device 340 may comprise a processor 395a, a memory 385b coupled to the processor 395a storing a client wireless protocol engine 388b that coordinates communication with the wireless access point 320. The wireless client device 340 may further comprise a communication interface (COMM I/F) 390b for receiving downstream transmissions and sending upstream transmissions over the virtual channel 350. Similarly, the server 362 may comprise a processor 395b coupled to a memory 385c storing a server engine 397 and a server wireless protocol engine 388c. While the server engine 397 may be a conventional server operating program, the server wireless protocol engine 388c may enable the bandwidth allocation protocol engine 388a to allocate bandwidth for transmission to the wireless client device 340. A communication interface (COMM I/F) 390c in the server 362 may enable data communications to and from the wireless access point 320 via the router 375 and the hub 370.

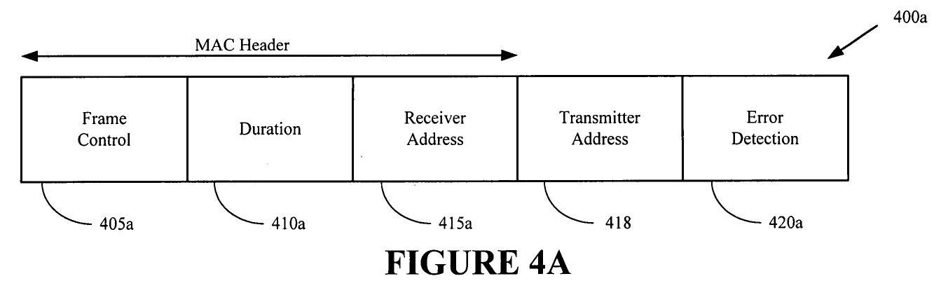

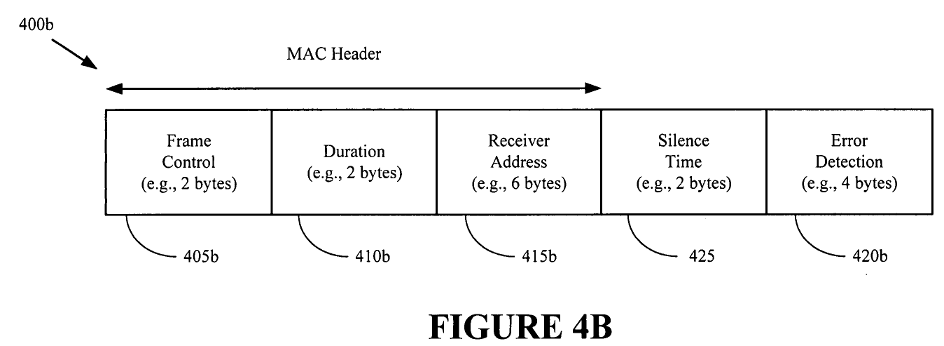

Referring to FIG. 4A, a frame format for a request-to-send (RTS) frame 400a is shown for the first frame 360a illustrated in FIG. 3 in accordance with one embodiment of the present invention. The RTS frame 400a comprises a medium access control (MAC) header and a plurality of fields including a frame control field 405a, a duration field 400a, a receiver address field 415a, a transmitter address field 418, and an error detection field 420a consistent with one embodiment of the present invention. The frame control field 405a indicates the kind of data of a current protocol data unit (PDU), which is a message of a given protocol comprising payload and protocol-specific control information, typically contained in a header. The duration field 410a indicates a duration value in time, for example in microseconds, required to transmit the pending data, at least one clear-to-send (CTS), an acknowledgement (ACK), and multiple short interframe space intervals. The receiver address field 415a includes a receiver address of the wireless access point 320, on the wireless medium, i.e., the virtual channel 350 that is the intended immediate recipient of the pending data. The transmitter address field 418 includes the transmitter address of the wireless client device 340 transmitting the RTS frame. The error detection field 420a includes a frame check sequence in one embodiment of the present invention.

Referring to FIG. 4B, a frame format for a clear-to-send frame (CTS) 400b is shown for the second frame 360b illustrated in FIG. 3 in accordance with one embodiment of the present invention. The CTS frame 400b may comprise a medium access control (MAC) header and a plurality of fields according to one embodiment of the present invention. The MAC header includes a frame control field 405b (e.g. two bytes), a duration field 410b (e.g., two bytes), and a receiver address field 415b (e.g. six bytes). In addition, the CTS frame 400b includes a silence time field 425 (e.g., two bytes) and an error detection field 420b (e.g., four bytes). In one embodiment, the silence time field 425 includes a value in terms of time e.g., in microseconds that the wireless client device 340 should minimally stay silent after transmitting the data. By calculating an appropriate value for a silence time, the wireless access point 320 may set an upper limit to the transmission bandwidth used by a particular client device.

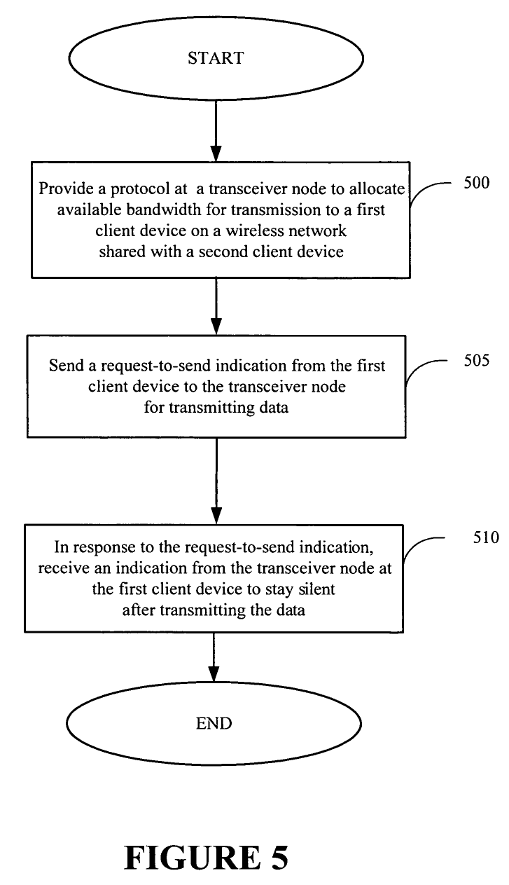

Referring to FIG. 5, a stylized representation of a method is shown for the wireless access point and (AP) 340 shown in FIG. 3 to control distribution of available bandwidth for transmission over a plurality of wireless client devices including the wireless client device 320 in accordance with one illustrative embodiment of the present invention. To control and coordinate usage of the shared wireless network 300, such as shown in FIG. 3, at block 500, a protocol, being a protocol extension of the IEEE 802.11 standard may be provided at the transceiver mode 120b. For example, the wireless access point 320 may allocate available bandwidth for transmission between a first client device 140d on the wireless network, such as the basic service set (BSS-B) 105b and a second client device 140e.

For transmitting data, at block 505, the first client device 140d may send a request-to-send indication to the transceiver node 120. As shown in block 510, in response to the request-to-send indication, the first client device 140d may receive an indication from the transceiver node 120b to stay silent after transmitting the data. In one embodiment, the virtual channel 350 may operate at 11 Mbps (the theoretical maximum for the IEEE 802.11b standard). The first client device 140d may request to send a packet of 1500 bytes, so ‘duration’ is 1040 us (1500*8/11 Mbps). The first client device 140d may be allocated 5.5 Mbps of available transmission bandwidth, and then by setting silence time to 1040 us, the wireless access point 320 may ensure that the first client device 140d effectively sends at that rate.

In one embodiment, calculations for allocation of the available transmission bandwidth may take channel conditions into account; according to a particular standard the wireless medium may operate at 1, 2, 5.5 and 11 Mbps depending on the virtual channel 350 conditions (e.g., noise, interference). In another embodiment, a fairness policy may be defined, by assigning 1/(2N)th part of the available transmission bandwidth to each wireless client device, where N is the number of wireless client devices. For example, the calculated values may compensate for protocol overhead and standard delay timers defined for the IEEE 802.11 standard.

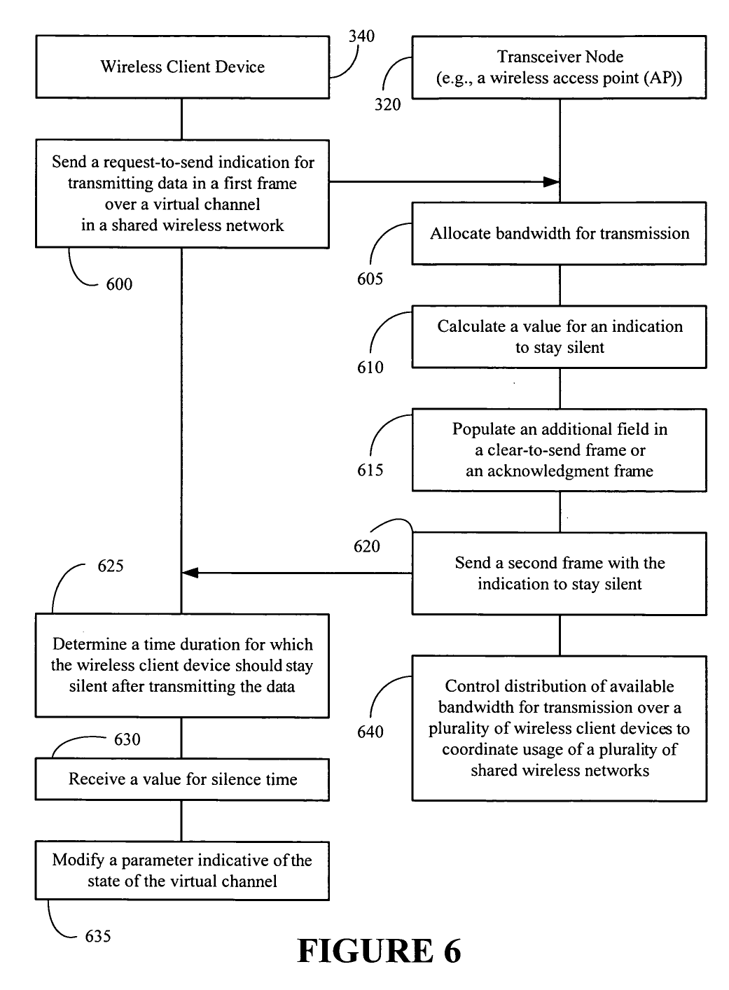

Referring to FIG. 6, a bandwidth allocation protocol for shared wireless networks for use with the bi-directional communication system 100 shown in FIG. 1 is illustrated in accordance with one embodiment of the present invention. The bandwidth allocation protocol 125 may allow the wireless access point (AP) 320 to control distribution of available bandwidth for transmission to the wireless client device 340. The wireless client device 340, as shown at block 600, may send a request-to-send indication for transmitting data in the first frame 360a over the virtual channel 350 in the shared wireless network 300. At block 605, the wireless access point 320 may allocate bandwidth for transmission. At block 610, the wireless access point 320 may calculate a value for an indication to stay silent for the wireless client device 340.

In one embodiment, the wireless access point 320 may populate an additional field, such as the silence time field 425 in the clear-to-send frame 400b, or alternatively, in an acknowledgement (ACK) frame, as shown in block 615. As indicated in block 620, the wireless access point 320 may send the second frame 360b to the wireless client device 340 with the indication to stay silent.

Upon receiving the indication to stay silent, the wireless client device 340, as shown at block 625, may determine a time duration for which the wireless client device 340 should stay silent after transmitting the data. In this manner, as illustrated at block 630, in the indication to stay silent, the wireless client device 340 may receive a value for silence time in the silence time field 420, indicating a time duration for which to stay silent after transmitting the data. In one embodiment, a value for the indication to stay silent may be calculated to set an upper limit on the bandwidth for transmission used by the wireless client device 340.

The wireless client device 340 may maintain a parameter indicative of the state of the virtual channel 350. Upon receipt of an extended frame, i.e., the CTS frame 400b, which includes a value for silence time as the indication to stay silent, the wireless client device 340 may modify the parameter. For example, the wireless client device 340 may maintain a network allocation vector (NAV) which represents the state of the virtual channel 350. Upon receipt of the CTS frame 400b, the wireless client device 340 may modify this NAV parameter to reflect the silent time it must respect after transmitting the data, as shown in block 635. In this manner, the wireless access point 320, as shown in block 640, may control distribution of available bandwidth for transmission over a plurality of devices, such as the wireless client devices 140a-140e to coordinate usage of a plurality of shared wireless networks, e.g., the basic service sets (BSS-A) 105a, and (BSS-B) 105b shown in FIG. 1.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method for allocating bandwidth for transmission to a first client device on a wireless network shared with a second client device, the method comprising:
sending a request-to-send indication to a transceiver node for transmitting data; and
receiving an indication at said first client device from said transceiver node to stay silent after transmitting the data in response to said request-to-send indication.

2. A method, as set forth in claim 1, further comprising:
determining a time duration from said indication to stay silent for which said first client device should stay silent after transmitting the data.

3. A method, as set forth in claim 2, further comprising:
receiving said time duration in a clear-to-send indication from said transceiver node.

4. A method, as set forth in claim 3, further comprising:
populating an additional field in a frame to indicate a value in terms of time for said time duration.

5. A method, as set forth in claim 4, further comprising:
sending the additional field in a clear-to-send frame from said transceiver node.

6. A method, as set forth in claim 1, further comprising:
controlling distribution of available said bandwidth for transmission over said first client device and said second client device.

7. A method, as set forth in claim 1, further comprising:
allowing a wireless access point to coordinate usage of said wireless network from said transceiver node; and
calculating a value for said indication to stay silent to set an upper limit on said bandwidth for transmission used by said first client device.

8. A method, as set for in claim 7, further comprising:
maintaining a parameter indicative of the state of a virtual channel at said first client device.

9. A method, as set forth in claim 8, further comprising:
receiving a value for silence time in said indication to stay silent in an extended frame; and
modifying said parameter indicative of the state of a virtual channel based on said value for silence time.

10. A method, as set forth in claim 4, further comprising:
sending the additional field in an acknowledgement frame from said transceiver node.

11. An article comprising a computer readable storage medium storing instructions that, when executed cause a processor-based system to:
send a request-to-send indication to a transceiver node for transmitting data on a wireless network shared between a first and a second client device; and
receive an indication at said first client device from said transceiver node to stay silent after transmitting the data in response to said request-to-send indication.

12. An article, as set forth in claim 11, comprising a medium strong instructions that, when executed cause a processor-based system to:
determine a time duration from said indication to stay silent for which said first client device should stay silent after transmitting the data.

13. An article, as set forth in claim 12, comprising a medium strong instructions that, when executed cause a processor-based system to:
receive said time duration in a clear-to-send indication from said transceiver node.

14. An article, as set forth in claim 13, comprising a medium strong instructions that, when executed cause a processor-based system to:
populate an additional field in a frame to indicate a value in terms of time for said time duration.

15. An article, as set forth in claim 14, comprising a medium strong instructions that, when executed cause a processor-based system to:
send the additional field in a clear-to-send frame from said transceiver node.

16. An article, as set forth in claim 11, comprising a medium strong instructions that, when executed cause a processor-based system to:
control distribution of available said bandwidth for transmission over said first client device and said second client device.

17. An article, as set forth in claim 11, comprising a medium strong instructions that, when executed cause a processor-based system to:
allow a wireless access point to coordinate usage of said wireless network from said transceiver node; and
calculate a value for said indication to stay silent to set an upper limit on said bandwidth for transmission used by said first client device.

18. An article, as set forth in claim 17, comprising a medium strong instructions that, when executed cause a processor-based system to:
maintain a parameter indicative of the state of a virtual channel at said first client device.

19. An article, as set forth in claim 18, comprising a medium strong instructions that, when executed cause a processor-based system to:
receive a value for silence time in said indication to stay silent in an extended frame; and
modify said parameter indicative of the state of a virtual channel based on said value for silence time.

20. An article, as set forth in claim 14, comprising a medium strong instructions that, when executed cause a processor-based system to:
send the additional field in an acknowledgement frame from said transceiver node.

21. A transceiver node for use with a first client device on a wireless network shared with a second client device, the transceiver node comprising:
a controller;
a memory coupled to said controller, said memory storing instructions for allocating bandwidth for transmission to said first and second client devices; and
a communication interface coupled to said controller, said communication interface capable of sending downstream transmissions and receiving upstream transmissions over a virtual channel for upstream communication and downstream communication, said virtual channel to transmit and receive data in a series of frames including a first frame and a second frame, said first frame to provide a request-to-send indication for transmitting data to said transceiver node and said second frame to provide an indication from said transceiver node to said first client device to stay silent after transmitting the data in response to said request-to-send indication.

22. A transceiver node, as set forth in claim 21, wherein said transceiver node is a wireless access point and said instructions for allocating bandwidth for transmission define a bandwidth allocation protocol in a network protocol stack at a medium access control layer.

23. A transceiver node, as set forth in claim 21, wherein said wireless network is a cellular communication network and said first and said second client devices are wireless communication devices.

24. A transceiver node, as set forth in claim 21, wherein said first frame is a request-to-send frame and said second frame is a clear-to-send frame.

25. A transceiver node, as set forth in claim 21, wherein said first frame is a request-to-send frame and said second frame is an acknowledgment frame.

26. A bi-directional communication system in which a bandwidth allocation protocol is deployed for communicating with a plurality of wireless networks in cooperation with a server, the system comprising:
a virtual channel for upstream communication and downstream communication;
a wireless access point capable of sending downstream transmissions and receiving upstream transmissions over said virtual channel; and
a plurality of wireless client devices capable of receiving said downstream transmissions and sending said upstream transmissions, at least one of said wireless client devices capable of sending a request-to-send indication to said wireless access point for transmitting data and receiving an indication from said wireless access point to stay silent after transmitting the data in response to said request-to-send indication.

27. A bi-directional communication system, as set forth in claim 26, wherein said bandwidth allocation protocol is deployed in a network protocol stack at a medium access control layer.

28. A bi-directional communication system, as set forth in claim 26, wherein said plurality of wireless networks include cellular communication networks.

29. A bi-directional communication system, as set forth in claim 26, wherein said virtual channel to transmit and receive data in a series of frames including a first frame and a second frame, said first frame is a request-to-send frame and said second frame is a clear-to-send frame and said plurality of wireless networks defined at least in part by the IEEE 802.11 standard.

30. A bi-directional communication system, as set forth in claim 26, wherein said virtual channel to transmit and receive data in a series of frames including a first frame and a second frame, said first frame is a request-to-send frame and said second frame is an acknowledgment frame and said plurality of wireless networks defined at least in part by the IEEE 802.11 standard.
